(19) United States
(12) Patent Application Publication
(10) Pub. No.: US 2026/0368063 A1
(43) Pub. Date: Nov. 19, 2026

(54) TECHNIQUES FOR HEAD-BASED GLOBAL TRACE MATERIALIZATION

(71) Applicant: SAP SE, Walldorf (DE)

(72) Inventor: Timm Felden, Malsch (DE)

(21) Appl. No.: 19/212,095

(22) Filed: May 19, 2025

(51) Int. Cl. G06F 11/34; G06F 11/07

(52) U.S. Cl. CPC G06F 11/3466; G06F 11/079

(57) ABSTRACT

In some implementations, the techniques may include accessing a global list of data center names and trace receiver endpoints. The techniques may include designating each of a plurality of data centers for receiving trace data for particular services. The techniques may include receiving a request for a service at a first data center. The techniques may include sending a request for service to one or more other data centers including identifying information for a specific data center responsible for a specific trace. The techniques may include receiving service activity information detailing one or more sub steps for the service. The techniques may include receiving trace data from other data centers, limiting the trace data based on the identifying information for the specific data center responsible for a specific trace. The techniques may include storing the trace data containing the service activity information for the one or more sub steps.

### BACKGROUND

Software products can be offered to customers as products. These software products can be integrated and often can be monitored to determine a source of issues when failures occur. One goal of software management can be to determine how the different services work together.

In one non-limiting example, a federation of databases can include some local databases. If remote databases are added to allow structured query language (SQL) execution against the remote tables, then all sorts of issues can occur.

A common solution to improve supportability is to use distributed tracing. Distributed tracing is a method for observing and monitoring requests as they flow through a distributed system (e.g., a microservices-based application). Tracing activity in a cloud-based network service presents unique challenges compared to traditional on-premises environments.

A common approach is to instrument the services to transmit trace data and then send the trace data to a common observability back-end. In this approach an observability back-end receives all the activity data and a complete picture of the activities of the overall flow can be determined.

Splitting large monolithic software into services may result in traditional support and billing models that no longer work properly. What may be needed instead is a means of following individual actions in the resulting network of services. However, simply sending information about all application programming interface (API) calls processed by network services exceeds economic and sometimes even technical limits. This issue must be solved in order to deliver the quality of support in the cloud that customers are used to from the on-premises world.

In the cloud, not all services are deployed in each data center. This results in requests spanning multiple services to cross data center boundaries. In turn, the only way to know what an entire request chain does would be to use one central global storage. However, this would result in some setups resulting in even the cheapest local requests to be stored in a global sink. Consequently, just the request data transfer to the global store could exceed the available internet bandwidth between the data center and the global store's data center.

Hence, this approach cannot be followed. Sampling rates, the state-of-the-art approach here, can equally not work for many network provider setups.

If a networked system has a hundred services contributing to a request, even a sampling rate of 1% would result in traces to be present on average with exactly one contributing service. Such information is not desirable for both support and billing.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

In one general aspect, a computer implemented method may include accessing a global list of data center names and trace receiver endpoints. This method may also include designating each of a plurality of data centers for receiving trace data for particular services based on the global list. The method may furthermore include receiving a request for a service at a first data center, where the service is at least partially performed with data from one or more other data centers. The method may include sending a request for service to one or more other data centers, the request for service including identifying information for a specific data center responsible for a specific trace. The method may include receiving service activity information detailing one or more sub steps for the service from one or more other data centers. The method may also include receiving trace data from the one or more other data centers based on the global list, where the one or more other data centers processing the request limit the trace data based on the identifying information for the specific data center responsible for a specific trace. The method may furthermore include storing the trace data containing the service activity information for the one or more sub steps irrespective of a specific data center where the sub steps are physically executed. Other embodiments of this aspect include corresponding computer systems, apparatus, and computer programs recorded on one or more computer storage devices, each configured to perform the actions of the methods.

Implementations may include one or more of the following features. The computer implemented method may include generating a trace report based on the trace data. The computer implemented method may include determining a presence of errors in the trace data based at least in part on the trace report. The computer implemented method may include deleting the trace data when no errors are discovered in the trace data. The computer implemented method may include generating the global list of data center names and trace receiver endpoints. In various embodiments, the service activity information is enriched with the name of one or more other data centers executing sub step activity. In various embodiments, the trace data may include one or more request and response details, application-level tracing data, system and performance metrics, error and exception logs, security and access logs, or custom metadata.

Implementation of the described techniques may be performed by a system including various hardware components, as a method or process, or stored as a series of instructions on a computer-readable tangible medium.

The following detailed description and accompanying drawings provide a better understanding of the nature and advantages of various embodiments of the present disclosure.

### BRIEF DESCRIPTION OF THE DRAWINGS

FIG. 1 illustrates a first exemplary system for tracing service activity.

FIG. 2 illustrates a second exemplary system for tracing service activity in a global distributed network

FIG. 3 illustrates a third exemplary system for tracing service activity in a global distributed network.

FIG. 4 illustrates a fourth exemplary system for tracing service activity in a global distributed network.

FIG. 5 illustrates a fifth exemplary system for tracing service activity in a global distributed network.

FIG. 6 is a flowchart of an example process for head-based global trace materialization.

FIG. 7 illustrates an exemplary computer system for implementing various embodiments described above.

FIG. 8 illustrates an exemplary computing device for implementing various embodiments described above.

FIG. 9 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

One promising approach uses the observation that most requests are cheap and co-located. The goal is to have more traces in a store that can be co-located with most senders to result in an affordable cost and to stay within available bandwidth limits.

This goal is achieved by having a dedicated trace store for each data center. The root of the call hierarchy attaches that root data center to each request that it makes. Every component must forward the root data center unmodified similar to Trace identifier forwarding.

Every component sends its trace data to the attached root data center. The entire trace can be materialized in a particular network center and the network traffic is, hence, reduced to a marginal fraction of the current state of the art.

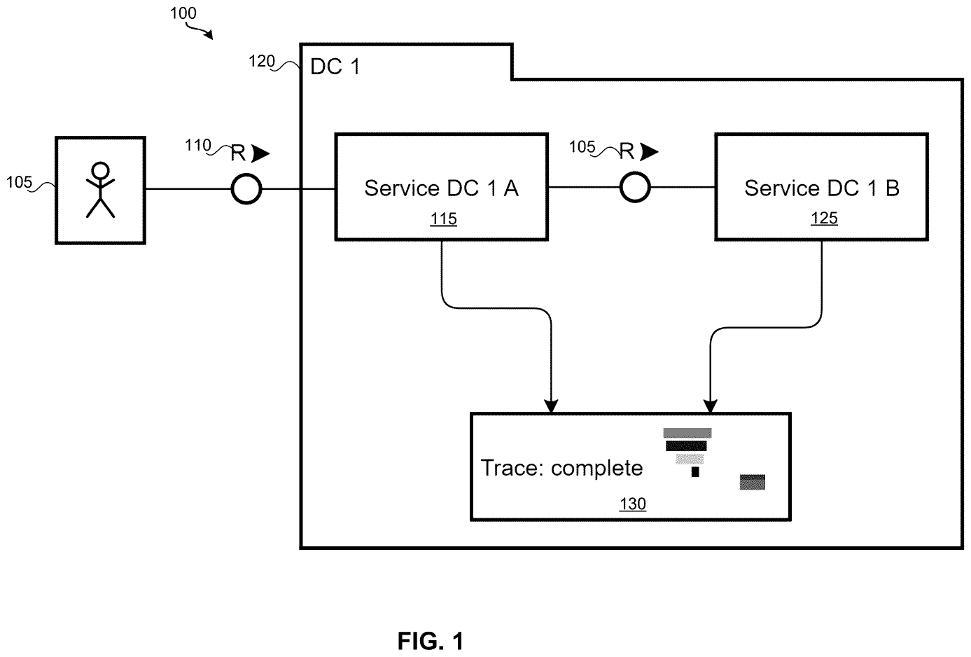

FIG. 1 illustrates a first exemplary system 100 for tracing service activity. A user 105 sends a request 110 for services to a first service (DC 1A) 115 within a first data center 120. The request 110 for services can include an electronic message containing information regarding the request.

A data center for a distributed service is a physical facility that houses the hardware and infrastructure needed to run parts of that distributed service-such as servers, storage systems, networking gear, and more. A data center is like one node in a much larger system. It can be akin to a “hub” where a chunk of the system lives-processing, storing, and routing data. Distributed services often run across multiple data centers in different regions or countries.

There are several reasons for using multiple data centers. One reason is fault tolerance. If one data center goes down, the other data centers can pick up the slack.

Another reason for multiple data centers is scalability. Multiple data centers can handle more users and more traffic. Another reason for multiple data centers is to reduce latency by serving users for the closest location data center. Multiple data centers can also be used for regulator compliance in order to store data where the laws require the data to be stored.

Each data center might host one or more services, databases, caches, etc. Data centers work together, sharing workloads, balancing traffic, or serving users based on location.

As shown in FIG. 1, user 105 makes a request 110 for services against a first service (DC 1A) 115. In order to fulfill that request, the first service (DC 1A) must request information from a second service (DC 1B) 125. In one non-limiting example, the second service (DC 1B) can be a central master data service.

The information from the second service (DC 1B) 125 can be provided to the first service (DC 1A) 115. The first service (DC 1A) 115 can provide a response to the user 105. In one non-limiting example, the response can include financial records (e.g., time sheets) for a payroll service.

The first service (DC 1A) 115 and the second service (DC 1B) 125 can provide trace data to a first trace data repository 130. Trace data in distributed tracing captures the lifecycle of a request as it travels through various services. Each trace consists of one or more spans, and each span includes detailed metadata.

Trace data can include a plurality of information. Trace data can include a Trace ID which can be a unique identifier for the entire request or transaction that can be shared across all spans in the trace.

Trace data can include a Span ID which can be a unique identifier for a specific operation within the trace. Each service or component the request touches can create a new span.

Trace data can include parent Span ID which can link spans in a hierarchy, showing which operation triggered which.

Trace data can include timestamps that record a start time and end time of each span. The timestamps can be used to calculate latency.

Trace data can include duration information which can be a total time the operation took.

Trace data can include a service name which can identify the service (e.g., user service, payment service) that created the span.

Trace data can include an operation name which can be a descriptive name of what the span is doing (e.g., GET/users, “insertOrderToDB”).

Trace data can include tags or attributes which can be key-value pairs that add context.

Trace data can include logs and/or events which can be time-stamped events within a span (e.g., retry attempts, exceptions). Logs and/or events can be useful for debugging specific steps.

Trace data can include resource information such as metadata about the host, container, region, or environment such as hostname, Internet Protocol (IP) address, Kubernetes pod ID, or a Cloud region.

Trace data can include custom context which can be any business-specific metadata (e.g., “user_id,” “order_id,” “transaction_id”).

An issue with these tracing techniques is that these techniques may only work for a single data center. If fulfillment of service requires some global connection of instances of multiple data centers there may be gaps in the information from partial traces of the services.

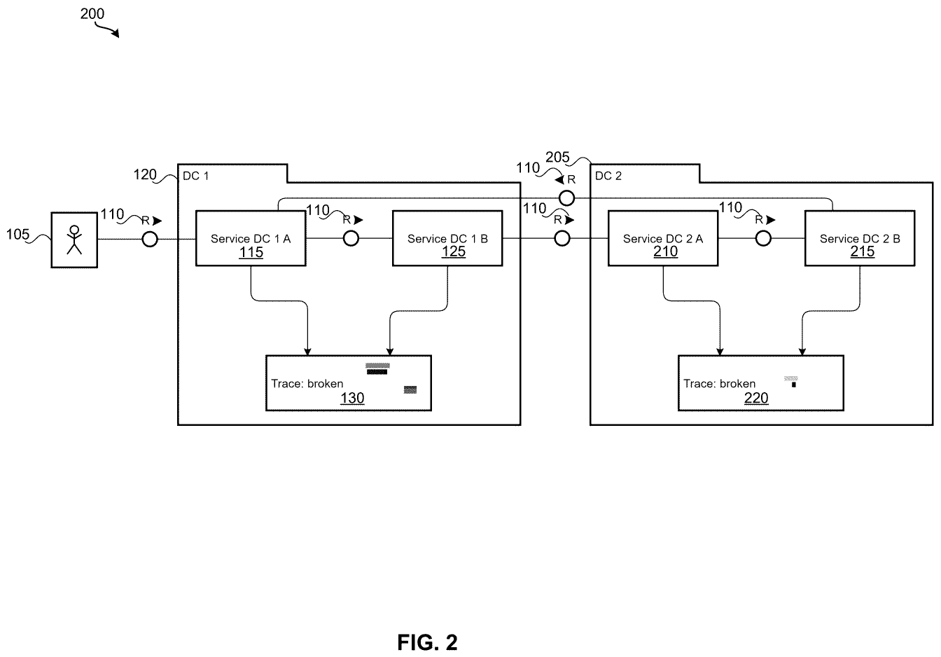

FIG. 2 illustrates a second exemplary system 200 for tracing service activity in a global distributed network. In the global distributed network, requests can go over multiple data centers and multiple service instances in those data centers. A user 105 sends a request 110 for services to a first service (DC 1A) 115 within a first data center 120.

As shown in FIG. 2, user 105 makes a request 110 for services against a first service (DC 1A) 115. In order to fulfill that request, the first service (DC 1A) requests information from a second service (DC 1B) 125. The second service (DC1B) 125 requests information from a third service (DC 2A) 210 that is in a second data center 205. The third service (DC 2A) can send the request 110 to a fourth service (DC 2B) 215.

The first trace data repository 130 can capture activity from the first service (DC 1A) 115 and the second service (DC 1B) 125. A second trace data repository 220 can capture activity data from the third service (DC 2A) and the fourth service (DC 2B) 215.

The result of this type of global distributed network would be that each data center can see the activity within the data center, but there would be gaps in the activity diagram for tracing purposes. The end result is that there can be broken traces in the first trace data repository 130 and the second trace data repository 220 because neither data repository would have the complete activity data to conduct a complete trace.

Diagnosing overall activity for handling service requests from customers would become more complex because of the incomplete trace data only consisting of local trace data.

In addition, trace data can take up storage space and often it can be removed from a data center if not required. Therefore, if diagnosing a problem in another data center the relevant trace data for diagnosing issues may not be available because it was previously deleted.

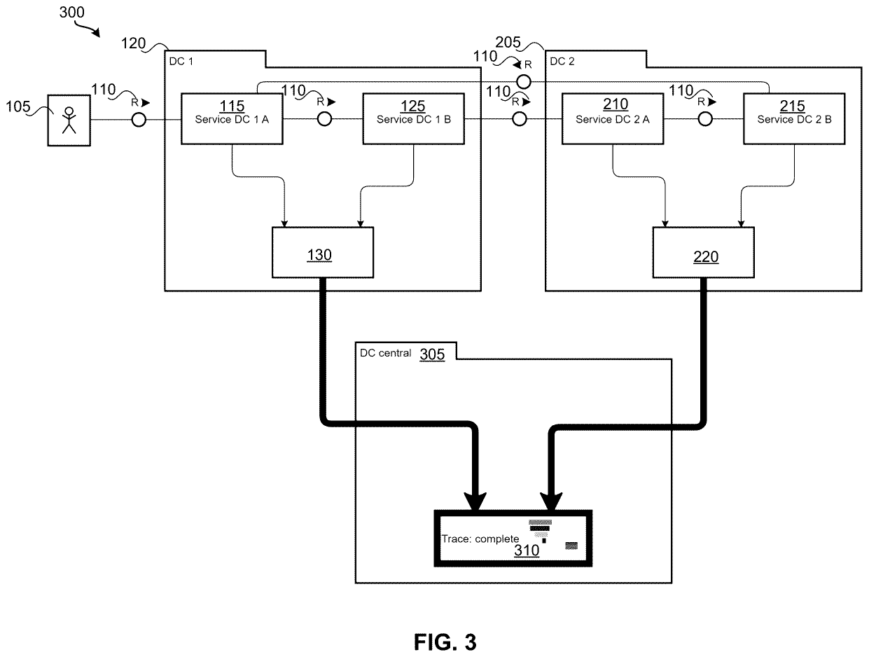

FIG. 3 illustrates a third exemplary system 300 for tracing service activity in a global distributed network. In the global distributed network, requests can go over multiple data centers and multiple service instances in those data centers. A user 105 sends a request 110 for services to a first service (DC 1A) 115 within a first data center 120.

As shown in FIG. 3, a user 105 makes a request 110 for services against a first service (DC 1A) 115. In order to fulfill that request, the first service (DC 1A) requests information from a second service (DC 1B) 125. The second service (DC1B) 125 requests information from a third service (DC 2A) 210 that is in a second data center 205. The third service (DC 2A) can send the request 110 to a fourth service (DC 2B) 215.

The first trace data repository 130 can capture activity from the first service (DC 1A) 115 and the second service (DC 1B) 125. A second trace data repository 220 can capture activity data from the third service (DC 2A) and the fourth service (DC 2B) 215. The trace data can be sent from the first trace data repository 130 and the second trace data repository 220 can be sent to a central trace repository 310. Using these techniques, the trace can be completed because the central trace repository 310 would have access to all the service information used for completing the trace.

Therefore, the issue of broken traces can be solved by sending all the trace data to the central trace repository 310. The issue with the third exemplary system 300 is that it can require a large bandwidth for sending and receiving all the trace data from the distributed systems over the global Internet. Some data centers do not have sufficient bandwidth for this approach.

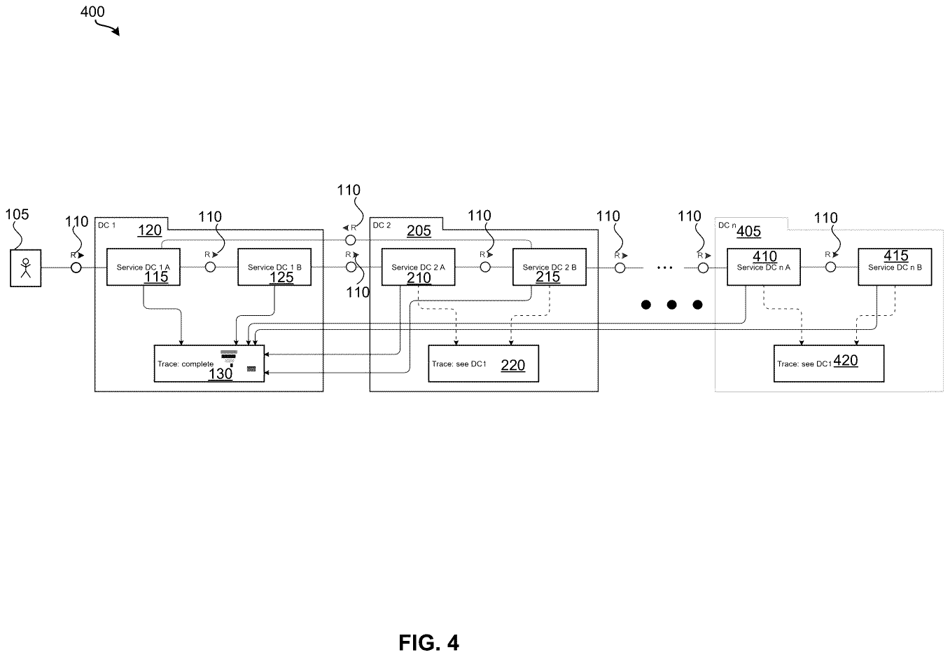

FIG. 4 illustrates a fourth exemplary system 400 for tracing service activity in a global distributed network. In the global distributed network, requests can go over multiple data centers and multiple service instances in those data centers. A user 105 sends a request 110 for services to a first service (DC 1A) 115 within a first data center 120. In order to fulfill that request, the first service (DC 1A) requests information from a second service (DC 1B) 125. The second service (DC1B) 125 requests information from a third service (DC 2A) 210 that is in a second data center 205. The third service (DC 2A) can send the request 110 to a fourth service (DC 2B) 215. A second trace data repository 220 can capture activity data from the third service (DC 2A) and the fourth service (DC 2B) 215.

The first trace data repository 130 can capture activity from the first service (DC 1A) 115 and the second service (DC 1B) 125. A second trace data repository 220 can capture activity data from the third service (DC 2A) and the fourth service (DC 2B) 215. The first trace data repository 130 can receive the requests from all requests 110 including services 210, 215, 410 and 415.

In the fourth exemplary system 400, there can be static data center names. The static data center names can provide color to the data center responsive for trace services. In this way, only selected trace data needs to be sent over the network to the designated data centers reducing the bandwidth requirement for trace data.

The name of the responsible data center can be forwarded with the request for services. In that way, the distributed data centers can identify the responsible data center for receiving the trace data. The data centers can then send only the trace data for the particular activities to the designated data center. By doing this the amount of trace data sent over the global Internet would be reduced.

Returning to FIG. 4, the fourth exemplary system 400 can include a plurality of data centers from the first data center 120, the second data center 205 to the nth data center 405. Each data center can host a plurality of services. While two services are depicted in each data center, any number of services can be hosted in each data center. For example, the nth data center 405 can host the fifth service (DC nA) 410 and sixth service (DC nB) 415. In a fourth exemplary system, the first data center 120 can be designated to receive trace data for a particular service. The first trace data repository 130 can receive the trace data from the first service (DC 1A) 115 and the second service (DC 1B) 125. The request 110 to the second data center 205 can be tagged with label for the first data center 120 for trace data for a particular service. The third service (DC 2A) and the fourth service (DC 2B) can send the trace data for the particular service to the first trace data repository 130. The first trace data repository 130 can receive the requests from all requests 110 including services 210, 215, 410 and 415. In this way, the trace data from the third service (DC 2A) and the fourth service (DC 2B) is not being sent to other data centers (e.g., the nth data center 405), therefore reducing the bandwidth requirements for collecting the trace data in a single data repository.

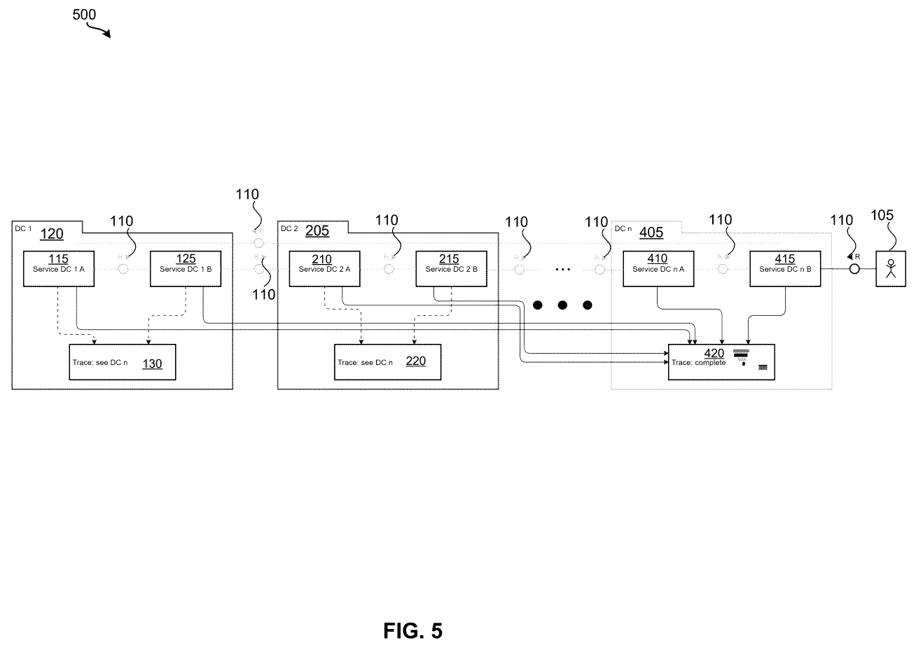

FIG. 5 illustrates a fifth exemplary system 500 for tracing service activity in a global distributed network. In the global distributed network, requests can go over multiple data centers and multiple service instances in those data centers. A user 105 sends a request 110 for services to a sixth service (DC nB) 415 within the nth data center 405.

In order to fulfill that request, the sixth service (DC nB) 415 requests information from the fifth service (DC nA) 410. The fifth service (DC nA) 410 requests information from a fourth service (DC 2B) 215 that is in a second data center 205. The fourth service (DC 2B) 215 can send the request 110 to a third service (DC 2A) 210. The third service (DC 2A) 210 can send the request to the second service (DC 1B) 125 and the first service (DC 1A) 115 in the first data center 120. As the request 110 is tagged with the information for the nth data center 405, the trace data related to the request 110 for services can be sent from the first service (DC 1A) 115, the second service (DC 1B) 125, the third service (DC 2A) 210, the fourth service (DC 2B) 215, the fifth service (DC nA) 410 and the sixth service (DC nB) 415 to the nth trace data repository 420. As the nth trace data repository 420 has all the trace information, the trace can be completed.

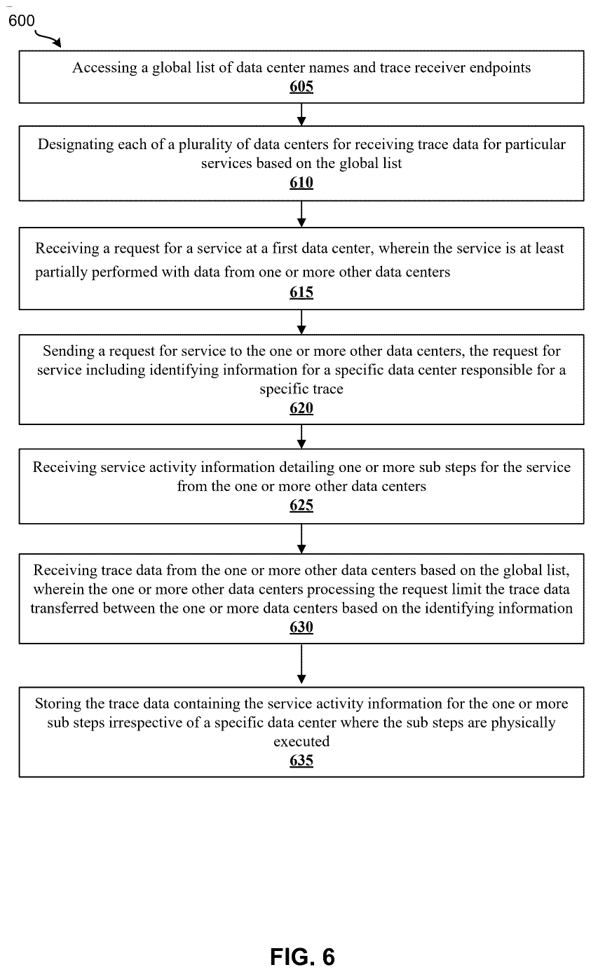

FIG. 6 is a flowchart of an example process 600 for head-based global trace materialization. In some implementations, one or more process blocks of FIG. 6 may be performed by one or more computing devices.

As shown in FIG. 6, process 600 may include accessing, at block 605, a global list of data center names and trace receiver endpoints. For example, the computing device may access a global list of data center names and trace receiver endpoints, as described above.

The global list of data center names can be stored in a memory. The global list of data center names can associate a data center with trace responsibilities for respective services. As further shown in FIG. 6, process 600 may include, at block 610, designating each of a plurality of data centers for receiving trace data for particular services based on the global list. Approaches used for management APIs or similar can be used here, too. For example, the computing device may designate each of a plurality of data centers for receiving trace data for particular services based on the global list, as described above.

The global list would contain at least an OTLP endpoint and credentials for that endpoint for each participating data center. The global list could even be public if credentials are managed in a separate shared secret store. One could present it as a table with columns (key, endpoint, credentials) where key is sent with each request and a copy of the table is present or accessible in each data center.
For instance:
DC1|mydc.com/myspace/tracereceiver|<secret>
DC2|otherdc.org/something/tracereceiver|<secret>
Note: “key” is “identifying information for a specific data center.” In general, key and endpoint could be the same but would not be in practice here since it would imply a lot of overhead. In general, endpoint could be derivable from key by convention and key could be e.g., the technical name of a hyper scaler region. In various embodiments, there could even be a global redirect service and a single set of static credentials e.g., “tracing.sap/<key>.” As also shown in FIG. 6, process 600 may include receiving, at block 615, a request for a service at a first data center, where the service is at least partially performed with data from one or more other data centers. For example, the computing device may receive a request for a service at a first data center, where the service is at least partially performed with data from one or more other data centers, as described above. The request for services can be received electronically over a network (e.g., the Internet). In one non-limiting example, the service can be a financial planning tool, and the data can be financial data stored in a global repository in another data center.

Business logic execution, request execution, or data management can be split into subcomponents or data centers. Master data and metadata management could be examples.

Audit logging could also be an example of something that might not be present in the local data center, i.e., the request to store an audit log as a trace for the ongoing business step.

Accessing human resources data, filing leave requests are examples of business operations where some parts of processing can be distributed across multiple data centers. However, this can also be data management with arbitrary data. Other use cases are access to or reporting into global monitoring solutions like global billing or global availability monitoring.

As further shown in FIG. 6, process 600 may include sending, at block 620, a request for service to the one or more other data centers, the request for service including identifying information for a specific data center responsible for a specific trace. For example, the computing device may send a request for service to one or more other data centers, the request for service including identifying information for a specific data center responsible for a specific trace, as described above. The request for service can be sent electronically over a network (e.g., the Internet). For HTTP-based requests, a header can include data center information. There are other protocols where some sort of field in the request package needs to be used for this. The responsible data center could also be a static or dynamic property of the connection itself if the protocol does not have any room for such data. This may limit the reusability of connections. However, protocols without any means of representing metadata may struggle with tracing too since it would equally be unable to transport trace and span IDs. As also shown in FIG. 6, process 600 may include receiving, at block 625, service activity information detailing one or more sub steps for the service from one or more other data centers. For example, the computing device may receive service activity information detailing one or more sub steps for the service from the one or more other data centers, as described above. The service activity information can be received electronically over a network (e.g., the Internet). The state-of-the art example would be receiving a batch of spans via OTLP/gRPC. Example sub-steps could be: Submit Leave Request->Check Authorization of user->Process Leave Request->(Access Master Data->[cross DC] write access log to audit log service->[cross DC] dispatch audit log to DC with audit log storage->[cross DC] ingest audit log->store audit log)->Commit Leave Request.

If billing were “pay per use” a billing step would follow that chain and the billing system would likely not be in the same DC, too. An example from the Business Data Cloud would be requesting the partial or full copies of tables accessed in a query using the database distributed over multiple data centers. In that case, the sub-steps could send data to requesting database instance and the shape of the request could be a star or snowflake or a chain.

As further shown in FIG. 6, process 600 may include receiving, at block 630, trace data from the one or more other data centers based on the global list, where the one or more other data centers processing the request limit the trace data transferred between the one or more data centers based on the identifying information for the specific data center responsible for a specific trace. For example, computing device may receive trace data from the one or more other data centers based on the global list, where the one or more other data centers processing the request limit the trace data based on the identifying information for the specific data center responsible for a specific trace, as described above. The trace data can be received electronically over a network (e.g., the Internet).

As also shown in FIG. 6, process 600 may include storing, at block 635, the trace data containing the service activity information for the one or more sub steps irrespective of a specific data center where the sub steps are physically executed. For example, the computing device may store trace data containing the service activity information for the one or more sub steps irrespective of a specific data center where the sub steps are physically executed, as described above. The trace data can be stored in a memory (e.g., a cloud-based storage device). The memory can include any persistent and non-persistent memory devices.

In various embodiments, the trace data may include one or more of request and response details, application-level tracing data, system and performance metrics, error and exception logs, security and access logs, or custom metadata.

Process 600 may include additional implementations, such as any single implementation or any combination of implementations described below and/or in connection with one or more other processes described elsewhere herein.

In various embodiments, process 600 can include generating a trace report based on the trace data. A trace report is typically generated from trace data to help developers and system administrators understand the behavior of a system, such as how requests flow through services or how functions are executed in sequence. Trace data consists of spans, each representing a unit of work (e.g., a function call, an API request, a database query).

Spans can include metadata such as start and end timestamps, operation name, service name, parent span (if any), tags (e.g., status code, HTTP method), and logs or events.

Generating a trace report can include several steps. First, the trace data can be collected using a tracing tool/library (e.g., OpenTelemetry, Jaeger, Zipkin, AWS X-Ray). In various embodiments, the code can be instruments such that it emits spans during execution. The trace data can be exported to a collector or backend component.

Next, the process can include grouping and structuring the data. This can include combining all spans that share a trace ID into a single trace. The spans can be organized in a tree or directed acyclic graph (DAG), showing the parent-child relationships.

Next, the process can include analyzing the trace. This can include calculating durations (e.g., total trace time, time per span), detecting errors, bottlenecks, or unusual patterns (like long or missing spans), and identifying dependencies between services or components.

The next step can include generating the report. The report can summarize key data: trace ID, total duration, number of spans, errors, etc. The report can highlight slow or failing spans. The report can include flame graphs, Gantt charts, service maps, or span timelines to visualize the trace.

Last, the report can be exported or displayed. This can include using a user interface (e.g., Jaeger UI, Datadog APM, etc.) or export to a readable format (HTML, PDF, JSON). The report can generate summaries or alerts programmatically.

In various embodiments, process 600 can include determining a presence of errors in the trace data based at least in part on the trace report.

In various embodiments, process 600 can include deleting the trace data when no errors are discovered in the trace data. The amount of storage memory trace data takes up depends on several factors e.g., the number of traces, the number or spans per trace, the size of each span, the retention period, the participating data centers, and the sampling rate.

Each trace is a set of spans. A single user request could generate dozens or even hundreds of spans. The more microservices, function calls, or instrumented steps, the more spans per trace. Each span typically includes IDs (trace ID, span ID), timestamps, tags/attributes, logs, or events. Using a rough estimate: ~500 bytes to 2 kilobytes per span (can be higher with lots of tags/logs). A 30-day retention period will require larger storage than a 7-day retention period. 100% sampling means every trace is stored. Lower rates (e.g., 10%) reduce storage needs but may miss anomalies.

For example, using a light trace of 1 trace with 5 spans can require 5-15 KB. A medium trace of 1 trace and 20 spans can require 20-50 KB. A heavy trace can be 1 trace with 100 spans requiring 100-300 kilobytes. A high-volume app can be 1,000 traces/sec, 20 spans each requiring 2-5 gigabytes per day. If you have 1000 traces per second, with 20 spans per trace, each span averaging 1 KB, it will generate 1000*20*1 KB*60*60*24=~1.7 terabytes day.

Therefore, deleting the spans can free up storage memory that can be used for storing spans.

In various embodiments, process 600 can include generating the global list of data center names and trace receiver endpoints.

In various embodiments, process 600 can include the service activity information is enriched with the name of the one or more other data centers executing sub step activity.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

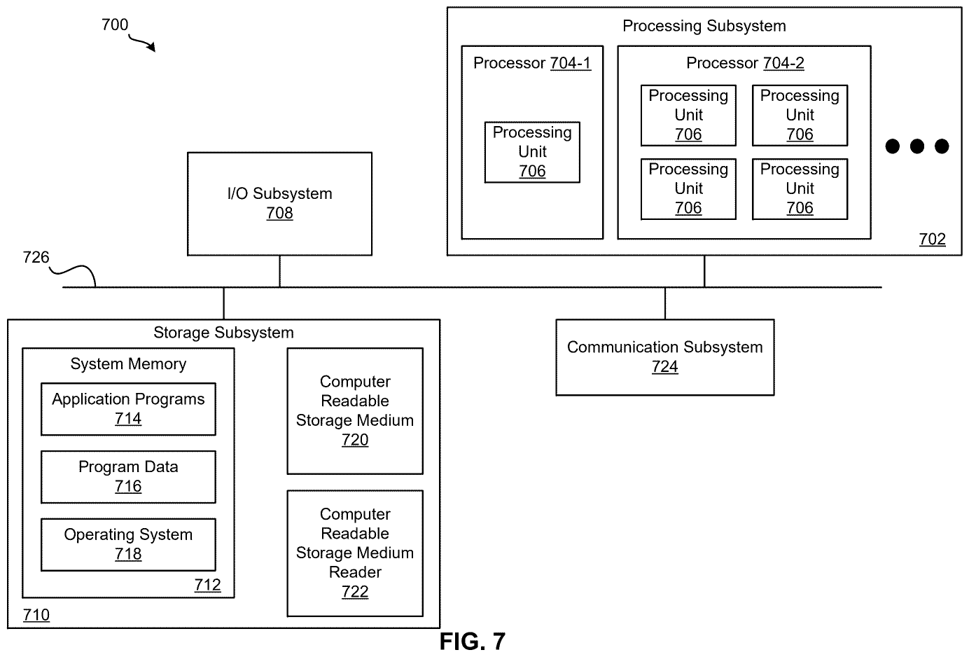

FIG. 7 illustrates a computer system 700 for implementing various embodiments described above. Computer system 700 may be a desktop computer, a laptop, a server computer, or any other type of computer system or combination thereof. In addition, computer system 700 can implement many of the operations, methods, and/or processes described above (e.g., process 600). As shown in FIG. 7, computer system 700 includes processing subsystem 702, which communicates via bus subsystem 726, with input/output (I/O) subsystem 708, storage subsystem 710 and communication subsystem 724.

Bus subsystem 726 is configured to facilitate communication among the various components and subsystems of computer system 700. While bus subsystem 726 is illustrated in FIG. 7 as a single bus, one of the ordinary skill in the art will understand that bus subsystem 726 may be implemented as multiple buses. Bus subsystem 726 may be any of several types of bus structures (e.g., a memory bus or memory controller, a peripheral bus, a local bus, etc.) using any of a variety of bus architectures. Examples of bus architecture may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 702, which can be implemented as one or more integrated circuits (e.g., a conventional microprocessor or microcontroller), controls the operation of computer system 700. Processing subsystem 702 may include one or more processors 704. Each processor 704 may include one processing unit 706 (e.g., a single core processor such as processor 704-1) or several processing units 706 (e.g., a multicore processor such as processor 704-2). In some embodiments, processors 704 of processing subsystem 702 may be implemented as independent processors while, in other embodiments, processors 704 of processing subsystem 702 may be implemented as multiple processors integrate into a single chip or multiple chips. Still, in some embodiments, processors 704 of processing subsystem 702 may be implemented as a combination of independent processors and multiple processors integrated into a single chip or multiple chips.

In some embodiments, processing subsystem 702 can execute a variety of programs or processes in response to program code and can maintain multiple concurrently executing programs or processes. At any given time, some or all of the program code to be executed can reside in processing subsystem 702 and/or in storage subsystem 710. Through suitable programming, processing subsystem 702 can provide various functionalities, such as the functionalities described above by reference to process 600.

I/O subsystem 708 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 700 to a user or another device (e.g., a printer).

As illustrated in FIG. 7, storage subsystem 710 includes system memory 712, computer-readable storage medium 720, and computer-readable storage medium reader 722. System memory 712 may be configured to store software in the form of program instructions that are loadable and executable by processing subsystem 702 as well as data generated during the execution of program instructions. In some embodiments, system memory 712 may include volatile memory (e.g., random access memory (RAM) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 712 may include several types of memory, such as static random-access memory (SRAM) and/or dynamic random-access memory (DRAM). System memory 712 may include a basic input/output system (BIOS), in some embodiments, which is configured to store basic routines to facilitate transferring information between elements within computer system 700 (e.g., during start-up). Such a BIOS may be stored in ROM (e.g., a ROM chip), flash memory, or any other type of memory that may be configured to store the BIOS.

As shown in FIG. 7, system memory 712 includes application programs 714, program data 716, and operating system (OS) 718. OS 718 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Computer-readable storage medium 720 may be a non-transitory computer-readable medium configured to store software (e.g., programs, code modules, data constructs, instructions, etc.). Many of the components and/or processes (e.g., process 600) described above may be implemented as software that when executed by a processor or processing unit (e.g., a processor or processing unit of processing subsystem 702) performs the operations of such components and/or processes. Storage subsystem 710 may also store data used for, or generated during, the execution of the software.

Storage subsystem 710 may also include computer-readable storage medium reader 722 that is configured to communicate with computer-readable storage medium 720. Together and optionally, in combination with system memory 712, computer-readable storage medium 720 may comprehensively represent remote, local, fixed, and/or removable storage devices plus storage media for temporarily and/or more permanently containing, storing, transmitting, and retrieving computer-readable information.

Computer-readable storage medium 720 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 724 serves as an interface for receiving data from, and transmitting data to other devices, computer systems, and networks. For example, communication subsystem 724 may allow computer system 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 724 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 724 may provide components configured for wired communication (e.g., Ethernet) in addition to or instead of components configured for wireless communication.

One of the ordinary skill in the art will realize that the architecture shown in FIG. 7 is only an example architecture of computer system 700, and that computer system 700 may have additional or fewer components than shown, or a different configuration of components. The various components shown in FIG. 7 may be implemented in hardware, software, firmware, or any combination thereof, including one or more signal processing and/or application specific integrated circuits.

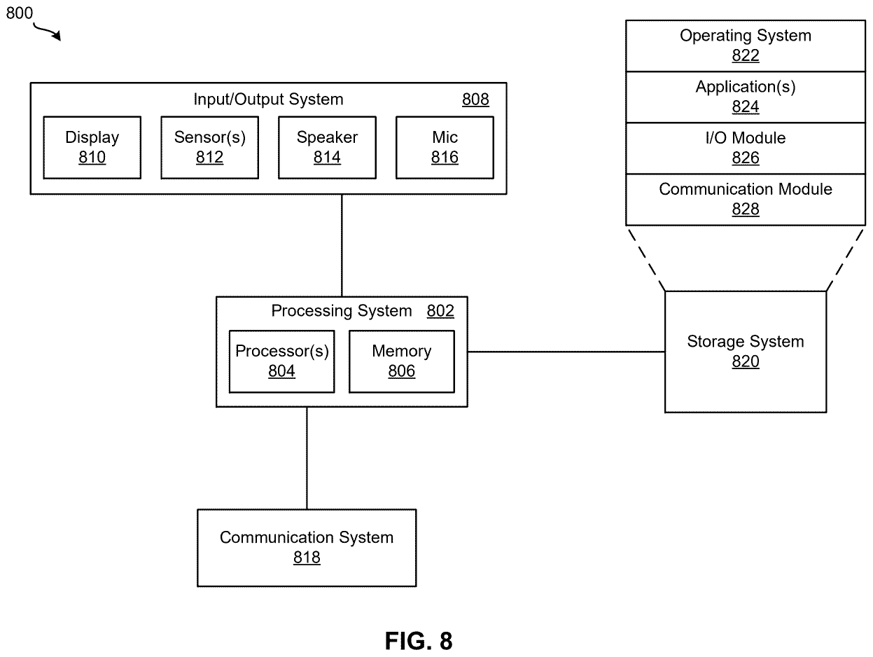

FIG. 8 illustrates an exemplary computing device 800 for implementing various embodiments described above. Computing device 800 may be a cellphone, a smartphone, a wearable device, an activity tracker or manager, a tablet, a personal digital assistant (PDA), a media player, or any other type of mobile computing device or combination thereof. In addition, computing device 800 can implement many of the operations, methods, and/or processes described above (e.g., process 600). As shown in FIG. 8, computing device 800 includes processing system 802, input/output (I/O) system 808, communication system 818, and storage system 820. These components may be coupled by one or more communication buses or signal lines.

Processing system 802, which can be implemented as one or more integrated circuits (e.g., a conventional microprocessor or microcontroller), controls the operation of computing device 800. As shown, processing system 802 includes one or more processors 804 and memory 806. Processors 804 are configured to run or execute various software and/or sets of instructions stored in memory 806 to perform various functions for computing device 800 and to process data.

Each processor of processors 804 may include one processing unit (e.g., a single core processor) or several processing units (e.g., a multicore processor). In some embodiments, processors 804 of processing system 802 may be implemented as independent processors while, in other embodiments, processors 804 of processing system 802 may be implemented as multiple processors integrated into a single chip. Still, in some embodiments, processors 804 of processing system 802 may be implemented as a combination of independent processors and multiple processors integrated into a single chip.

Memory 806 may be configured to receive and store software (e.g., operating system 822, applications 824, I/O module 826, communication module 828, etc. from storage system 820) in the form of program instructions that are loadable and executable by processors 804 as well as data generated during the execution of program instructions. In some embodiments, memory 806 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 808 is responsible for receiving input through various components and providing output through various components. As shown for this example, I/O system 808 includes display 810, one or more sensors 812, speaker 814, and microphone 816. Display 810 is configured to output visual information (e.g., a graphical user interface (GUI) generated and/or rendered by processors 804). In some embodiments, display 810 is a touch screen that is configured to also receive touch-based input. Display 810 may be implemented using liquid crystal display (LCD) technology, light-emitting diode (LED) technology, organic LED (OLED) technology, organic electro luminescence (OEL) technology, or any other type of display technologies. Sensors 812 may include any number of several types of sensors for measuring a physical quantity (e.g., temperature, force, pressure, acceleration, orientation, light, radiation, etc.). Speaker 814 is configured to output audio information and microphone 816 is configured to receive audio input. One of the ordinary skill in the art will appreciate that I/O system 808 may include any number of additional, fewer, and/or different components. For instance, I/O system 808 may include a keypad or keyboard for receiving input, a port for transmitting data, receiving data and/or power, and/or communicating with another device or component, an image capture component for capturing photos and/or videos, etc.

Communication system 818 serves as an interface for receiving data from, and transmitting data to, other devices, computer systems, and networks. For example, communication system 818 may allow computing device 800 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 818 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 818 may provide components configured for wired communication (e.g., Ethernet) in addition to or instead of components configured for wireless communication.

Storage system 820 handles the storage and management of data for computing devices 800. Storage system 820 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 600) described above may be implemented as software that when executed by a processor or processing unit (e.g., processors 804 of processing system 802) perform the operations of such components and/or processes.

In this example, storage system 820 includes operating system 822, one or more applications 824, I/O module 826, and communication module 828. Operating system 822 includes various procedures, sets of instructions, software components and/or drivers for controlling and managing general system tasks (e.g., memory management, storage device control, power management, etc.) and facilitate communication between various hardware and software components. Operating system 822 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple iOS, Windows Phone, Windows Mobile, Android, BlackBerry OS, Blackberry 10, and Palm OS, WebOS operating systems.

Applications 824 can include any number of different applications installed on computing device 800. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 826 manages information received via input components (e.g., display 810, sensors 812, and microphone 816) and information to be outputted via output components (e.g., display 810 and speaker 814). Communication module 828 facilitates communication with other devices via communication system 818 and includes various software components for handling data received from communication system 818.

One of ordinary skill in the art will realize that the architecture shown in FIG. 8 is only an example architecture of computing device 800, and that computing device 800 may have additional or fewer components than shown, or a different configuration of components. The various components shown in FIG. 8 may be implemented in hardware, software, firmware, or any combination thereof, including one or more signal processing and/or application specific integrated circuits.

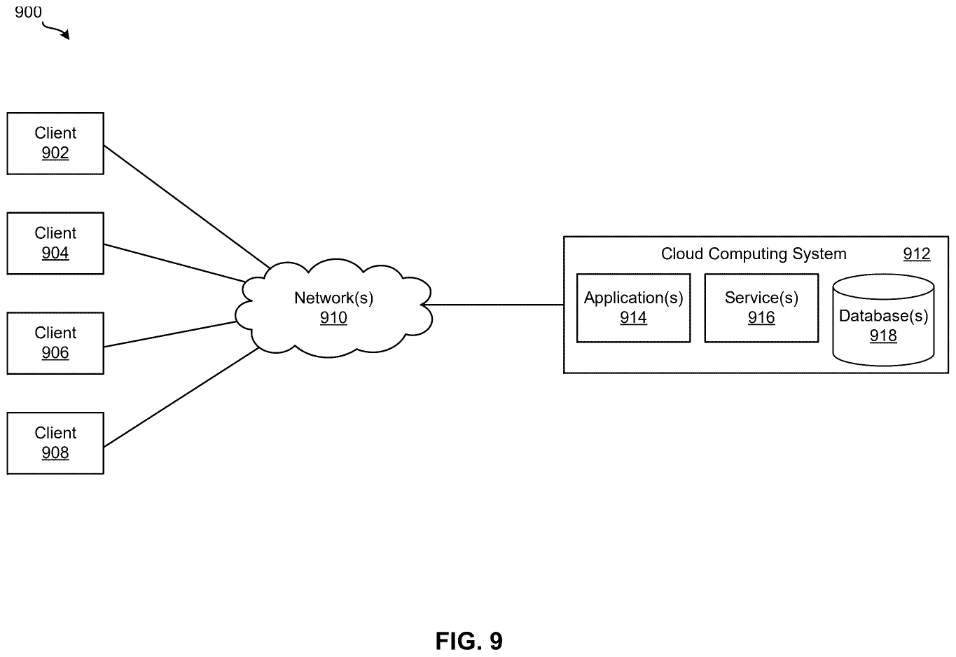

FIG. 9 illustrates an exemplary system 900 for implementing various embodiments described above. For example, any client devices 902, 904, 906, 908 may be used to implement the cloud computing system 912. As shown, system 900 includes client devices 902, 904, 906, and 908, one or more networks 910, and cloud computing system 912. Cloud computing system 912 is configured to provide resources and data to client devices 902, 904, 906, and 908 via networks 910. In some embodiments, cloud computing system 912 provides resources to any number of different users (e.g., customers, tenants, organizations, etc.). Cloud computing system 912 may be implemented by one or more computer systems (e.g., servers), virtual machines operating on a computer system, or a combination thereof.

As shown, cloud computing system 912 includes one or more applications 914, one or more services 916, and one or more databases 918. Cloud computing system 912 may provide applications 914, services 916, and databases 918 to any number of different customers in a self-service, subscription-based, elastically scalable, reliable, highly available, and secure manner.

In some embodiments, cloud computing system 912 may be adapted to automatically provision, manage, and track a customer's subscriptions to services offered by cloud computing system 912. Cloud computing system 912 may provide cloud services via different deployment models. For example, cloud services may be provided under a public cloud model in which cloud computing system 912 is owned by an organization selling cloud services and the cloud services are made available to the public or different industry enterprises. As another example, cloud services may be provided under a private cloud model in which cloud computing system 912 is operated solely for a single organization and may provide cloud services for one or more entities within the organization. The cloud services may also be provided under a community cloud model in which cloud computing system 912 and the cloud services provided by cloud computing system 912 are shared by several organizations in a related community. The cloud services may also be provided under a hybrid cloud model, which is a combination of two or more of the aforementioned different models.

In some instances, any one of applications 914, services 916, and databases 918 made available to client devices 902, 904, 906, and 908 via networks 910 from cloud computing system 912 is referred to as a “cloud service.” Typically, servers and systems that make up cloud computing system 912 are different from the on-premises servers and systems of a customer. For example, cloud computing system 912 may host an application and a user of one of client devices 902-908 may order and use the application via networks 910.

Applications 914 may include software applications that are configured to execute on cloud computing system 912 (e.g., a computer system or a virtual machine operating on a computer system) and be accessed, controlled, managed, etc. via client devices 902-908. In some embodiments, applications 914 may include server applications and/or mid-tier applications (e.g., HTTP (hypertext transfer protocol) server applications, FTP (file transfer protocol) server applications, CGI (common gateway interface) server applications, JAVA server applications, etc.). Services 916 are software components, modules, applications, etc. that are configured to execute on cloud computing system 912 and provide functionalities to client devices 902-908 via networks 910. Services 916 may be web-based services or on-demand cloud services.

Databases 918 are configured to store and/or manage data that is accessed by applications 914, services 916, and/or client devices 902-908. For instance, the customer sales data may be stored in databases 918. Databases 918 may reside on a non-transitory storage medium local to (and/or resident in) cloud computing system 912, in a storage-area network (SAN), on a non-transitory storage medium local located remotely from cloud computing system 912. In some embodiments, databases 918 may include relational databases that are managed by a relational database management system (RDBMS). Databases 918 may be a column-oriented databases, row-oriented databases, or a combination thereof. In some embodiments, some or all of databases 918 are in-memory databases. That is, in some such embodiments, data for databases 918 are stored and managed in memory (e.g., random access memory (RAM)).

Client devices 902-908 are configured to execute and operate a client application (e.g., a web browser, a proprietary client application, etc.) that communicates with applications 914, services 916, and/or databases 918 via networks 910. This way, client devices 902-908 may access the various functionalities provided by applications 914, services 916, and databases 918 while applications 914, services 916, and databases 918 are operating (e.g., hosted) on cloud computing system 912. Although system 900 is shown with four client devices, any number of client devices may be supported.

Networks 910 may be any type of network configured to facilitate data communications among client devices (e.g., first client device 902, second client device 904, third client device 906, and fourth client device 908) and cloud computing system 912 using any of a variety of network protocols. Networks 910 may be a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

1. A computer implemented method comprising:
accessing a global list of data center names and trace receiver endpoints;
designating each of a plurality of data centers for receiving trace data for particular services based on the global list;
receiving a request for a service at a first data center, wherein the service is at least partially performed with data from one or more other data centers;
attaching, by a root of a call hierarchy, identifying information of a root data center to the request;
sending a request for service to the one or more other data centers, the request for service including the identifying information for a specific data center responsible for a specific trace, wherein the identifying information identifies the root data center, and wherein the root data center is forwarded unmodified by each component processing the request;
receiving service activity information detailing one or more sub steps for the service from the one or more other data centers;
receiving trace data from the one or more other data centers based on the global list, wherein the one or more other data centers processing the request limit the trace data transferred between the one or more other data centers based on the identifying information for the specific data center responsible for a specific trace, wherein each component sends its trace data to the root data center according to the identifying information attached to the request; and
storing the trace data containing the service activity information for the one or more sub steps irrespective of a specific data center where the sub steps are physically executed.

2. The computer implemented method of claim 1 further comprising generating a trace report based on the trace data.

3. The computer implemented method of claim 2, further comprising determining a presence of errors in the trace data based at least in part on the trace report.

4. The computer implemented method of claim 2, further comprising deleting the trace data when no errors are discovered in the trace data.

5. The computer implemented method of claim 1, further comprising generating the global list of data center names and trace receiver endpoints.

6. The computer implemented method of claim 1, wherein the service activity information is enriched with a name of the one or more other data centers executing sub step activity.

7. The computer implemented method of claim 1, wherein the trace data comprises one or more of request and response details, application level tracing data, system and performance metrics, error and exception logs, security and access logs, or custom metadata.

8. A non-transitory computer-readable medium storing a set of instructions, that, when executed by one or more processors of a device, cause the device to perform operations comprising:
accessing a global list of data center names and trace receiver endpoints;
designating each of a plurality of data centers for receiving trace data for particular services based on the global list;
receiving a request for a service at a first data center, wherein the service is at least partially performed with data from one or more other data centers;
attaching, by a root of a call hierarchy, identifying information of a root data center to the request;
sending a request for service to the one or more other data centers, the request for service including the identifying information for a specific data center responsible for a specific trace, wherein each component sends its trace data to the root data center according to the identifying information attached to the request;
receiving service activity information detailing one or more sub steps for the service from the one or more other data centers;
receiving trace data from the one or more other data centers based on the global list, wherein the one or more other data centers processing the request limit the trace data transferred between the one or more other data centers based on the identifying information for the specific data center responsible for a specific trace; and
storing the trace data containing the service activity information for the one or more sub steps irrespective of a specific data center where the sub steps are physically executed.

9. The non-transitory computer-readable medium of claim 8, wherein the operations further comprise generating a trace report based on the trace data.

10. The non-transitory computer-readable medium of claim 9, wherein the operations further comprise determining a presence of errors in the trace data based at least in part on the trace report.

11. The non-transitory computer-readable medium of claim 9, wherein the operations further comprise deleting the trace data when no errors are discovered in the trace data.

12. The non-transitory computer-readable medium of claim 8, wherein the operations further comprise generating the global list of data center names and trace receiver endpoints.

13. The non-transitory computer-readable medium of claim 8, wherein the service activity information is enriched with a name of one or more other data centers executing sub step activity.

14. The non-transitory computer-readable medium of claim 8, wherein the trace data comprises one or more of request and response details, application level tracing data, system and performance metrics, error and exception logs, security and access logs, or custom metadata.

15. A system comprising:
one or more processors configured to access code stored in a memory to perform operations comprising:
accessing a global list of data center names and trace receiver endpoints;
designating each of a plurality of data centers for receiving trace data for particular services based on the global list;
receiving a request for a service at a first data center, wherein the service is at least partially performed with data from one or more other data centers;
attaching, by a root of a call hierarchy, identifying information of a root data center to the request;
sending a request for service to the one or more other data centers, the request for service including the identifying information for a specific data center responsible for a specific trace, wherein each component sends its trace data to the root data center according to the identifying information attached to the request;
receiving service activity information detailing one or more sub steps for the service from the one or more other data centers;
receiving trace data from the one or more other data centers based on the global list, wherein the one or more other data centers processing the request limit the trace data transferred between the one or more other data centers based on the identifying information for the specific data center responsible for a specific trace, wherein each component sends its trace data to the root data center according to the identifying information attached to the request; and
storing the trace data containing the service activity information for the one or more sub steps irrespective of a specific data center where the sub steps are physically executed.

16. The system of claim 15, wherein the operations further comprise generating a trace report based on the trace data.

17. The system of claim 16, wherein the operations further comprise determining a presence of errors in the trace data based at least in part on the trace report.

18. The system of claim 16, wherein the operations further comprise deleting the trace data when no errors are discovered in the trace data.

19. The system of claim 15 wherein the operations further comprise generating the global list of data center names and trace receiver endpoints.

20. The system of claim 15, wherein the service activity information is enriched with a name of one or more other data centers executing sub step activity.
